(19) United States
(12) Patent Application Publication
(10) Pub. No.: US 2015/0252785 A1
(43) Pub. Date: Sep. 10, 2015

(54) ROTARY MECHANISM COMPRISING A MODIFIED ROBERTS' LINKAGE

(71) Applicant: Peter Klein Meuleman, Venlo (NL)

(72) Inventor: Peter Klein Meuleman, Venlo (NL)

(21) Appl. No.: 14/415,157

(22) PCT Filed: Jul. 16, 2012
(86) PCT No.: PCT/EP2012/063918

§ 371 Date: May 19, 2015

(51) Int. Cl. F03D 7/02

(52) U.S. Cl. CPC F03D 7/0224

(57) ABSTRACT

A rotary mechanism comprising a first component (a wind turbine hub base), and a second component (a wind turbine blade base); configured for coaxial rotation relative to one another around a first axis. A mechanical linkage couples the first and second components together, allowing relative rotation and maintaining a constant spacing therebetween. The linkage is a modified embodiment of the Roberts' linkage comprising: a first rod, a second rod, a swiveling member (having a swiveling axis), and a swiveling shaft (comprising top and bottom parts); configured for constraining a relative movement of the first and second components to the coaxial rotation around the first axis. The bottom part is mounted to the swiveling shaft for swiveling around the swiveling axis. The swiveling axis and the first axis span a specific plane that is stationary with respect to a specific one of the first component and the second component.

### CROSS REFERENCE TO RELATED APPLICATIONS

This is a National Stage Application claiming the benefit of International Application Number PCT/EP2012/063918 filed on 16 Jul. 2012, which is incorporated herein by reference in its entirety.

### FIELD OF THE INVENTION

The invention relates to a rotary mechanism, comprising a first component and a second component configured for coaxial rotation relative to one another around a first axis. The invention also relates to a combination of a first component, a second component and a mechanical linkage for use in a rotary mechanism. The invention further relates to a further combination of a blade, a second component accommodated at the blade, and a pitch adjustment mechanism for use in a rotary mechanism that comprises a rotor hub and the blade mounted to the rotor hub. The invention also relates to a pitch adjustment mechanism configured for use in a rotary mechanism that comprises a rotor hub and a blade mounted to the rotor hub.

### BACKGROUND ART

A turbomachine is a rotational device configured for interacting with a fluid, e.g., air or water, in order to extract energy from the fluid flow by converting kinetic energy of the fluid flow into rotational energy of a rotor assembly, or to transmit kinetic energy to the fluid by converting the rotational energy of the rotor assembly into a thrust.

A turbine, e.g., a wind turbine, has a rotational device configured for extracting energy from the fluid flow and for converting the extracted energy into useful work. A turbine has a moving part, referred to as the rotor assembly, which includes a shaft or a rotor hub, with blades attached to the shaft or to the rotor hub. Moving fluid acts on the blades so that the blades move and impart rotational energy to the rotor assembly.

A propeller, e.g., of a ship or of an aircraft, is an example of a device that transmits power by converting rotational motion into thrust. The propeller also has a rotor assembly which includes a shaft or a rotor hub, with blades attached to the shaft or the rotor hub. A pressure difference is produced between the forward and rear surfaces of each blade as the blade rotates around the shaft or the rotor hub, and the fluid is accelerated behind the blade.

The blades of a wind turbine or of a propeller may be mounted to the shaft via an adjusting mechanism that is configured for controllably turning each blade for adjusting the pitch or: angle of attack (AOA) of the each blade. In the field of fluid dynamics, the AOA refers to the angle between a reference line on the blade and a vector representing the relative motion between the blade and the fluid through which the blade is moving. In a wind turbine, adjustment of the AOA enables to adjust the rotation speed of the (driven) shaft or rotor hub, and to thereby adjust the generated power. The adjustment of the AOA can also be used to control the torque delivered by the rotor and/or the power generated by the wind turbine. A propeller of an aircraft or of a ship uses the adjustment of the AOA to control the speed of the aircraft or of the ship relative to the fluid, without changing the rotation of the shaft or the rotor hub so as to increase efficiency of the engine driving the shaft or the rotor hub.

Typically, a pitch adjustment mechanism connects each respective one of the blades to the rotor hub through a respective rotational bearing of some kind.

A known pitch adjustment mechanism uses a slewing bearing mounted coaxially with an axis of the blade around the blade is turned in order to adjust the blade's pitch. Slewing bearings are large-size rolling element bearings that can accommodate axial loads, radial loads and bending moment loads acting either singly or in combination and in any direction. Slewing bearings can perform both slewing (oscillating) movements as well as rotational movements.

Basically, a slewing bearing comprises an inner ring, an outer ring and rolling elements (e.g., balls or cylindrical rollers) that are separated by spacers, made of, e.g., polyamide. The inner ring and the outer ring, one of which usually incorporates a gear, are provided with holes to accommodate attachment bolts. The holes may be threaded. Generally, only the raceways in the inner ring and the raceways in the outer ring are hardened and precision-ground. Integral seals made of, for example, acrylonitrile-butadiene rubber (NBR) keep lubricants in, and contaminants out of the slewing bearing. Slewing bearings are re-lubricated through grease fittings in order to reduce maintenance and operating costs. Compared to traditional pivot arrangements, slewing bearing arrangements provide many design and performance advantages. The compactness and large inner diameter simplify the design of the bearing arrangement and its associated components. The low sectional height of slewing bearings implies that the pinion lever can be kept short. In most cases only flat surfaces on the associated components are needed. Slewing bearings were originally designed to be mounted only on horizontal support structures, but can now be used successfully in vertical bearing arrangements (for more background see, e.g., “Slewing Bearings” SKF Publication 06115 EN, September 2009).

Another approach is disclosed in International Application Publication WO2011/095349, assigned to SKF and incorporated herein by reference. The International Application Publication WO2011/095349 relates to a wind turbine blade pitch bearing device, adapted for rotational support of a turbine blade and having a first bearing unit and a second bearing unit coaxial to the first bearing unit. The first bearing unit and the second bearing unit are of different bearing types. By using two different bearing types, one bearing can be optimized for small and quick rotations and the other type can be optimized for larger and slower rotations. Therefore, the International Application Publication WO2011/095349 discloses splitting the rotational support of the blade on the rotor hub into two degrees of freedom, and using one type of bearing for relatively large angular adjustments (coarse pitch, e.g., up to 90 degrees) and another type of bearing for small back and forth adjustments of up to, e.g., 5 degrees of fine pitch).

### SUMMARY OF THE INVENTION

The known approaches discussed above each have their individual advantages. However, one of the drawbacks common to the above known approaches is that, in order to be able to replace the bearings that allow adjusting the pitch of the blade, the blade has to be disconnected and removed from the rotor hub. Removal of the blade from the rotor hub is a fairly expensive exercise especially on a wind turbine. Another drawback is that the known approaches involve the use of large rolling element bearings, whose rolling elements are subjected to oscillatory (back-and-forth) movements in operational use. As known, under normal operation conditions, a rolling element bearing has a thin layer of a lubricant that separates the rolling elements from the bearing's raceways. If the rolling elements are subjected to small back-and-forth movements relative to the raceways, the lubricant gets pushed away from the loaded zones of the raceways and the displaced lubricant is not replaced while the small back-and-forth movements continue. This may lead to damage to the raceways and/or to the rolling elements, in terms of material wear and debris, a phenomenon being referred to as “false brinelling”.

Accordingly, the inventors have recognized that the drawbacks in the known approaches may get solved by an alternative configuration of a rotary mechanism with a first component and a second component, which are configured for coaxial rotation relative to one another around a first axis, wherein the first component and the second component are coupled via a mechanical linkage that is configured for constraining a relative movement of the first component and the second component to the coaxial rotation around the first axis.

The inventors therefore propose a rotary mechanism comprising a first component and a second component configured for coaxial rotation relative to one another around a first axis. The first component and the second component are coupled via a mechanical linkage that is configured for constraining a relative movement of the first component and the second component to the coaxial rotation around the first axis. The mechanical linkage comprises: a first rod; a second rod; a swiveling member; and a swiveling shaft. The swiveling shaft has a swiveling axis. The swiveling member has a top part and a bottom part. The top part of the swiveling member has a first end and a second end, different from the first end. The bottom part is mounted to the swiveling shaft for swiveling around the swiveling axis. The swiveling axis and the first axis span a specific plane that is stationary with respect to a specific one of the first component and the second component. The first rod is coupled between the first end and a first portion of the specific one of the first component and the second component. The second rod is coupled between the second end and a second portion of the specific one of the first component and the second component, different from the first portion.

The feature “mechanical linkage” refers to an assembly of rigid links (i.e., physical bodies) connected together so as to manage forces and movement. The connections between the links are referred to as joints.

The mechanical linkage in the invention is based on the well known Roberts' linkage, developed by Richard Roberts (1789-1864). During the Industrial Revolution (1750-1850), technology was beginning to have an ever increasing and profound impact on all aspects of society. The technology of the day was symbolized by the developments of the steam engine and its applications. In a steam engine, a piston moves up and down a cylinder under control of the admittance and release of steam under pressure. A connecting rod attached to the piston drives a mechanical linkage so as to translate the up and down movement of the piston into, e.g., a rotary movement or a sideways movement. The movements of the piston within the cylinder needed to be constrained to a straight line in order to minimize friction and wear of the piston and of cylinder wall, so as to optimize efficiency. The engineers at the time therefore focused on the problem of how to have a physical object trace a straight line in the absence of a straight reference edge. The Roberts' linkage is an elegant solution to this problem in a planar space, needing two fixed points and three bars.

The Roberts' linkage can be thought of as comprising a rigid element in the form of a capital letter “T”. That is, the rigid element has a cross-bar and a stem, wherein one end of the stem is rigidly attached to the middle of the cross-bar and wherein the stem and the cross-bar make a right angle. The first end of the cross-bar of the capital letter “T” is connected via a first joint to one end of a first arm, and the second end of the cross-bar of the capital letter “T” is connected via a second joint to one end of a second arm. The first arm and the second arm have equal lengths. The other end of the first arm is connected to a stationary rigid reference frame via a third joint, and the other end of the second arm is connected to the stationary rigid reference frame via a fourth joint. The first joint, the second joint, the third joint and the fourth joint allow the Robert's linkage to change its shape in the plane comprising the first arm, the second arm and the rigid element in the form if the capital letter “T”. The assembly formed by the rigid element in the shape of the capital letter “T”, the first arm and the second arm is such that a virtual line connecting the third joint and the fourth joint and the cross-bar of the capital letter “T” are parallel if a first angle between the first arm and the cross-bar equals a second angle between the second arm and the cross-bar. Now, if the first angle and the second angle are being changed, the other end of the stem of the rigid element in the form if the capital letter “T” opposite the cross-bar traces, in good approximation, a straight path parallel to the virtual line connecting the first joint and the second joint. The quality of the approximation of the straight path improves with increased lengths of the arms while retaining the proportions of the mechanical linkage.

In the invention, the path to be controlled by the mechanical linkage is the relative movement between the first component and the second component. This path is not a straight line, but a circle segment. Accordingly, the elegant Roberts' linkage as is cannot be used to control the relative movement between the first component and the second component. Some deep and clever thinking by the inventors has gone into solving the problem of how to modify the Roberts' linkage so as to apply the principles of the Roberts' linkage to control a path that is a circle segment. The result is the mechanical linkage specified earlier, and based on having the swiveling member swivel around an axis that makes an angle with the axis of the circle that comprises the circle segment.

In an embodiment of the rotary mechanism of the invention, the specific one of the first component and the second component has a first shaft coaxial with the first axis; and the other one of the first component and the second component engages with the specific shaft via a bearing. The modified linkage is configured to take up axial loads and bending moment, meaning that the bearing need only support the radial load. Consequently, a bearing with a relatively small pitch diameter can be used, which has the advantage that a relatively small amount of friction is generated. The bearing may be a plain bearing or a rolling element bearing.

This configuration facilitates replacing the bearing as the configuration does not require that the first component and the second component need be disconnected from each other when replacing the bearing.

A further embodiment of the rotary mechanism of the invention comprises at least one of the following characteristics: the first rod is coupled to the first end of the swiveling member via a first joint that comprises one of: a first ball joint and a first rod end bearing; the second rod is coupled to the second end of the swiveling member via a second joint that comprises one of: a second ball joint and a second rod end bearing; the first rod is coupled to the specific one of the first component and the second component via a third joint that comprises one of: a third ball joint and a third rod end bearing; and the second rod is coupled to the specific one of the first component and the second component via a fourth joint that comprises one of: a fourth ball joint and a fourth rod end bearing.

In operational use of the rotary mechanism, the relative movement of the first rod with respect to the swiveling member and with respect to the relevant one of the first component and the second component comprises a rotation of the first rod around the axis of the first rod. The relative movement of the first rod with respect to the swiveling member also comprises a further rotation that varies a first angle between, on the one hand, the axis of the first rod and, on the other hand, a virtual line between the first end and the second end at the top part of the swiveling member. The relative movement of the first rod with respect to the specific one of the first component and the second component also comprises another rotation that varies a second angle between the axis of the rod and a plane perpendicular to the first axis. Therefore, it is preferred that the specific one of the first component and the second component, on the one hand, and the swiveling member, on the other hand, be interconnected by means of the first rod and the second rod via joints that allow such rotations. As known, a ball joint is a spherical bearing that allows three degrees of rotation (around an x-axis, around a y-axis and around a z-axis that together form a Cartesian frame of reference). As known, a rod end bearing (also known as a “Heim joint” or a “Rose joint”) comprises a ball swivel with an opening through which a bolt or a shaft may pass.

In a further embodiment of the rotary mechanism of the invention, the rotary mechanism comprises a rotor hub and a blade mounted to the rotor hub. The blade extends away from the rotor hub in a substantially radial direction relative to an axis of rotation of the rotor hub in operational use of the rotary mechanism. The rotor hub accommodates the first component. The blade accommodates the second component. The rotary mechanism comprises a pitch adjustment mechanism. The pitch adjustment mechanism is configured for controllably adjusting a pitch of the blade by turning the second component relative to the first component around the first axis. The pitch adjustment mechanism comprises the mechanical linkage.

The first rod and the second rod connect the specific one of the first component and the second component to the swiveling member. The swiveling member is connected to the swiveling shaft for turning around the swiveling shaft. The swiveling shaft is mounted stationary with respect to either the first component or the second component. Accordingly, the mechanical linkage implements the mechanical interconnection between the first component and the second component, in contrast with a bearing assembly conventionally implementing the mechanical interconnection. Any bearings present in the pitch adjustment mechanism of the invention can therefore be replaced without disconnecting the blade from the rotor hub. A temporary fixation of the mechanical linkage may be needed when a bearing is being replaced in order to prevent the mechanical linkage from collapsing and/or the blade of the rotary mechanism from making undesired movements.

Further, consider a mechanical interaction between the blade and the rotor hub relative to a frame of reference that comprises the first axis. Forces that are directed along the first axis and torques that are directed perpendicular to the first axis are managed by the mechanical linkage of the pitch adjustment mechanism in the invention.

As has been specified above, the swiveling axis and the first axis span a specific plane that is stationary with respect to a specific one of the first component and the second component; the first rod is coupled between the first end and a first portion of the specific one of the first component and the second component e; and the second rod is coupled between the second end and a second portion of the specific one of the first component and the second component, different from the first portion. That is, the mechanical linkage can be implemented in different ways. In one implementation, the first rod and the second rod connect the swiveling member to the second component, and the swiveling member swivels around the swiveling axis that is kept stationary with respect to the first component. It is clear that, in view of the relative movement of the first component and the second component, the connections could be inversed so that in another implementation of the mechanical linkage, the first rod and the second rod connect the swiveling member to the first component, and the swiveling member swivels around the swiveling axis that is kept stationary with respect to the second component.

The invention also relates to a combination of a first component, a second component and a mechanical linkage for use in the rotary mechanism of the invention.

The combination can be commercially exploited, e.g., as an after-market upgrade so as to provide rotary mechanisms, already installed and in operational use, with the combination, thereby introducing the advantages as mentioned above.

The invention also relates to a further combination of a blade, a second component, and a pitch adjustment mechanism for use in a rotary mechanism that comprises a rotor hub and a blade mounted to the rotor hub, wherein the blade has a hollow room, and wherein the pitch adjustment mechanism partially extends into the hollow room of the blade in operational use of the rotary mechanism.

The dimensions of the pitch adjustment mechanism and the magnitude of the excursions made by the moving parts of the mechanical linkage can be optimized under the constraints of the space available for accommodating the pitch adjustment mechanism. Accordingly, the dimensions and paths traversed by the moving parts are adjustable to the dimensions of the blade to be used. As a result, providing the further combination may provide another way in order to commercially exploit the invention.

The invention further relates to a pitch adjustment mechanism configured for use in the rotary mechanism that comprises a rotor hub and a blade mounted to the rotor hub.

### BRIEF DESCRIPTION OF THE DRAWINGS

The invention is explained in further detail, by way of example and with reference to the accompanying drawings, wherein:

FIG. 1 is a diagram of a wind turbine as an example of a rotary mechanism;

FIG. 2 is a diagram illustrating part of a rotor hub that carries the blades of the rotary mechanism;

FIGS. 3, 4 and 5 are diagrams to illustrate the concept of the invention based on a modification to the Roberts' linkage;

FIGS. 6 and 7 illustrate an example of the conventional Roberts' linkage; and

FIGS. 8, 9 and 10 illustrate the role of design parameters in optimizing the design.

Throughout the Figures, similar or corresponding features are indicated by same reference numerals.

### LEGEND

100: wind turbine
102: tower
104: first blade
106: second blade 106
108: third blade
110: rotor hub
112: nacelle
114: wind
116: rotor axis
202: first hub base/first component
204: first blade base/second component
206: first axis for turning the first blade to adjust pitch
304: first rod
306: second rod
308: swiveling member
310: swiveling shaft
311: support
312: swiveling axis
313: swiveling bearing
314: top part of swiveling member
316: bottom part of swiveling member
318: first end of top part
320: second end of top part
322: first portion of first blade base
324: first joint between first rod and first end
326: second joint between second rod and second end
328: third joint between first rod and blade base
330: fourth joint between second rod and blade base
332: actuator
334: further actuator
402: first shaft
404: second portion of first blade base
406: other actuator
502: hub bearing
600: Roberts' linkage
602: first arm of Roberts' linkage
604: second arm of Roberts' linkage
606: cross bar of intermediate element of Roberts' linkage
608: tail-part of Roberts' linkage
610: segment of straight line
802: imaginary circular disc
804: radius of the imaginary disc
902: first reference location
904: second reference location

### DETAILED EMBODIMENTS

A rotary mechanism in the invention, e.g., a wind turbine, has a rotor assembly comprising a rotor hub and a blade attached to the rotor hub via a mechanism for adjusting the pitch of the blade. The mechanism comprises a hub base at the rotor hub and a blade base at the base of the blade. The blade base and the hub base are connected via a modified embodiment of the Roberts' linkage so as to allow relative rotation between the hub base and the blade base while keeping a distance between the hub base and the blade base constant.

The mechanical linkage in the invention is explained below with reference to a rotary mechanism comprising a rotor hub and a blade mounted to the rotor hub. It is clear that the mechanical linkage of the invention can be applied in other applications wherein a first component and a second component are coupled through a mechanical linkage that confines the relative movement of the first component and the second component to a coaxial rotation at least to a good approximation. Below, the first component is referred to as “the first hub base” and the second component is referred to as the “first blade base”.

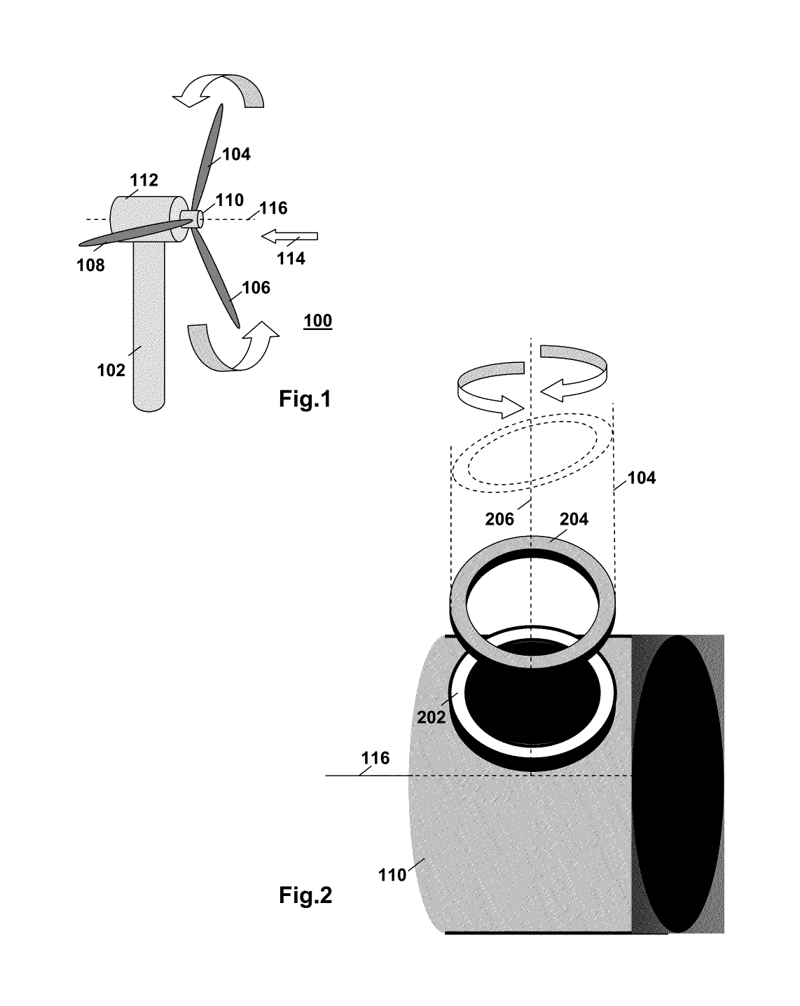

FIG. 1 is a diagram of a wind turbine 100 in an example of a rotary mechanism. The wind turbine 100 comprises a tower 102 that supports a rotary assembly. The rotary assembly comprises a rotor with a first blade 104, a second blade 106 and a third blade 108 mounted on a rotor hub 110. The rotor hub 110 is connected to a shaft (not shown) accommodated in a nacelle 112. The nacelle 112 accommodates the power generating components and control mechanisms known in the art. The rotor is driven by the wind 114 and rotates around a rotor axis 116. In the example of FIG. 1, the first blade 104, the second blade 106 and the third blade 108 are shown as having a heart line extending in a substantially radial direction relative to the rotor axis 116. Other rotor designs exist, wherein the heart line of a blade has a radial direction close to the rotor hub, and a radial directional component as well as an angular directional component farther away from the hub so as to give the blade a scimitar-like shape, notably in the field of aircraft propeller design.

For completeness, it is noted here that there are wind turbines that have a single blade, or two blades or more than two blades, mounted on a rotor hub, and all working as they should, even the one with the single-blade configuration. The rotational inertia of the blade in the single-blade configuration is compensated by having the rotational inertia of the power generating components mounted on the rotor hub opposite the single blade.

FIG. 2 is a diagram illustrating part of the rotor hub 110. The rotor hub 110 has a first hub base 202 coupled to a first blade base 204 of the first blade 104, a second hub base (not shown) coupled to a second blade base (not shown) of the second blade 106, and a third hub base (not shown) coupled to a third blade base (not shown) of the third blade 106. The first blade base 204 is mounted to the first hub base 202 so that the first blade 104 can be turned around a first axis 206 that extends in the radial direction relative to the rotor axis 116 in order to adjust the pitch of the first blade 104. Likewise, the second blade base is mounted to the second hub base so that the second blade 106 can be turned around a second axis (not shown) that extends in the radial direction relative to the rotor axis 116 in order to adjust the pitch of the second blade 106; and the third blade base is mounted to the third hub base so that the third blade 108 can be turned around a third axis (not shown) that extends in the radial direction relative to the rotor axis 116 in order to adjust the pitch of the third blade 106.

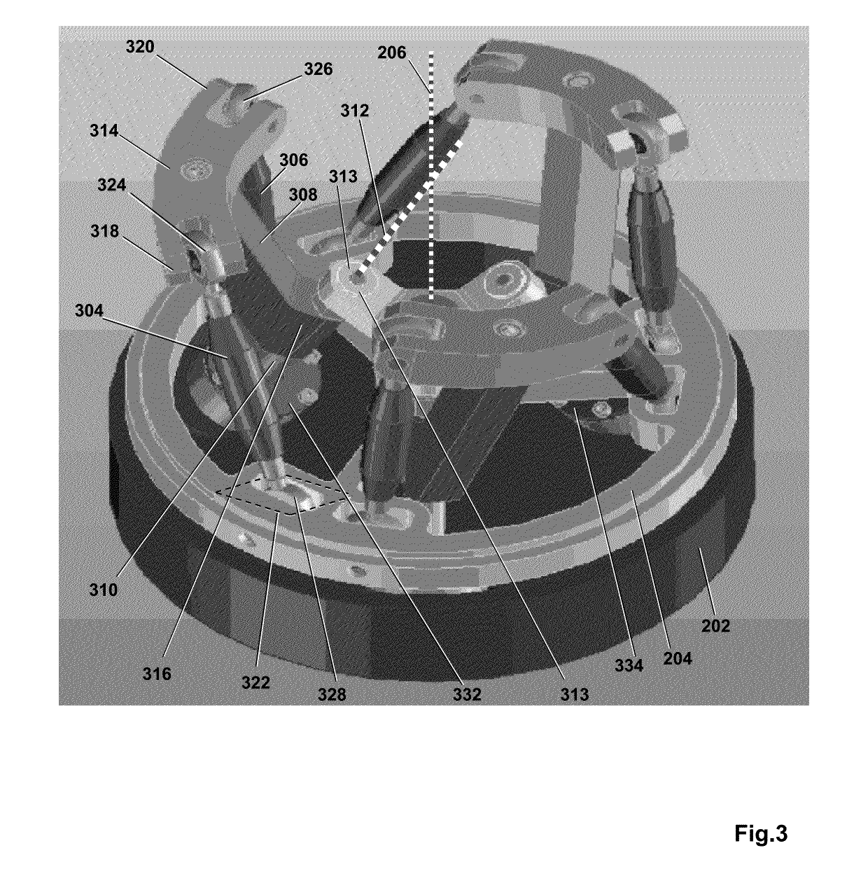

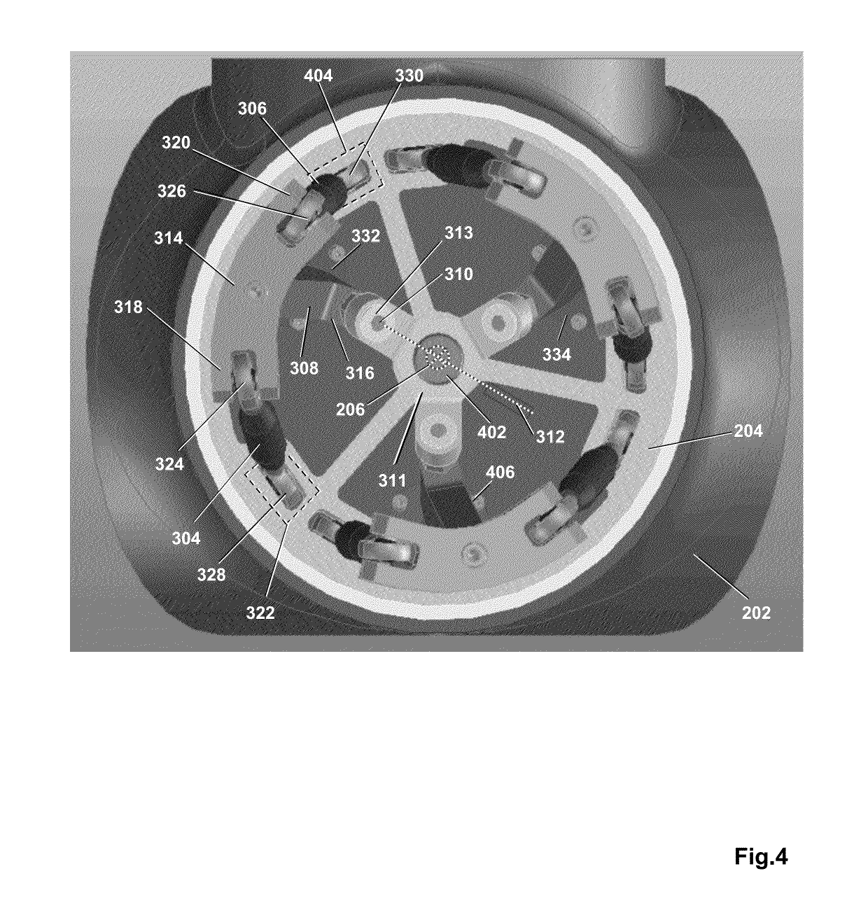

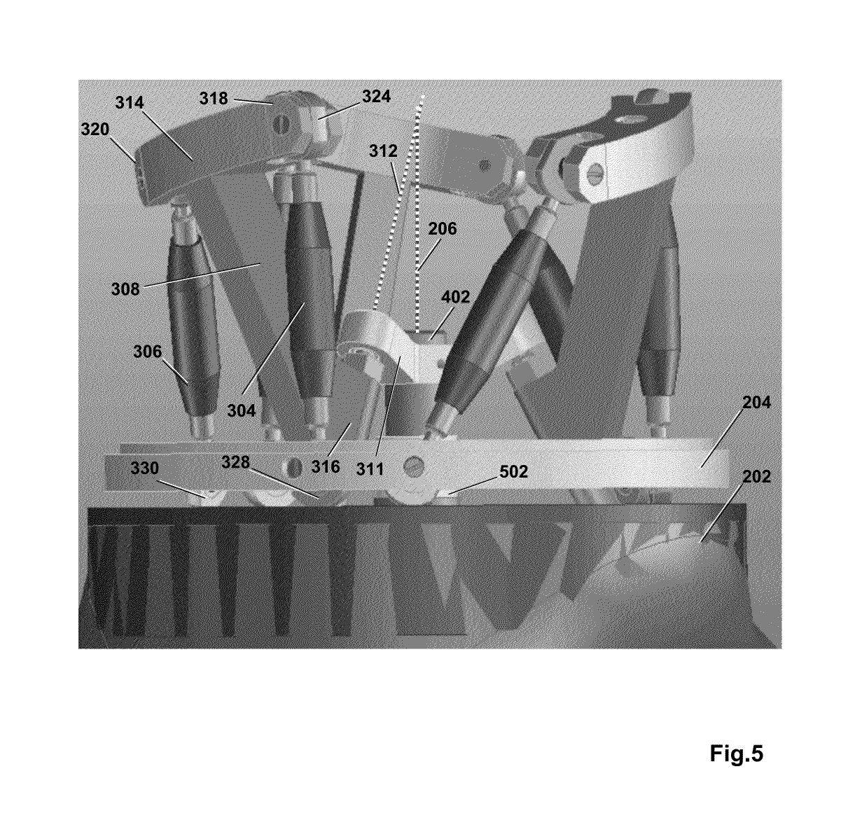

FIGS. 3, 4 and 5 are diagrams to illustrate the concept of the invention with reference to a model embodiment of a coupling of the first blade base 204 to the first hub base 202. Different ones of the diagrams of FIGS. 3, 4 and 5 show different views of the model embodiment. The coupling is implemented by means of a pitch adjustment mechanism. In the paragraphs below, reference is made to the diagrams of FIG. 3, FIG. 4 and FIG. 5 together, as different features of the coupling are better represented in the different views provided by the diagrams of FIG. 3, FIG. 4 and FIG. 5. Throughout the diagrams, the first digit of a reference numeral of a particular feature corresponds to the sequence number of the particular one of FIG. 3, FIG. 4 and FIG. 5, wherein the particular feature has been introduced first. For example, the feature with reference numeral 404 (“second portion of first blade base”) is introduced for the first time in the diagram of FIG. 4, whereas the feature with reference numeral 322 (“first portion of first blade base”) is introduced for the first time in the diagram of FIG. 3.

As specified earlier, the first blade 104, the second blade 106 and the third blade 108 are mounted to the rotor hub 110 of the rotary assembly of the wind turbine 100. The rotor hub 110 has a plurality of hub bases, of which the first hub base 202 has been indicated in FIG. 2. The configuration of the first hub base 202 is representative of the configurations of the second hub base and the third hub base mentioned earlier. Each specific one of the first blade 104, the second blade 106 and the third blade 108 has a specific blade base. The first blade base 204 is representative of the configurations of the second blade base and the third blade base mentioned earlier.

The first hub base has a first shaft 402 extending in the specific radial direction. The first blade base 204 is mounted to the first hub base 202 for coaxial rotation around a first axis 206 of the first shaft 402. A hub bearing 502 is mounted so as to allow relative coaxial rotation between the first blade base 204 and the first hub base 202. The hub bearing 502 comprises, e.g., a plain bearing. The first blade base 204 is mounted to the first shaft 402 through a pitch adjustment mechanism. The pitch adjustment mechanism is configured for controllably adjusting a pitch of the first blade 104 by turning the first blade base around the first axis 206. The pitch adjustment mechanism comprises a mechanical linkage between the first blade base 204 and the first hub base 202. The mechanical linkage is configured for constraining a movement of the first blade base 204 relative to the first hub base 202 to a coaxial rotation around the first axis 206.

The mechanical linkage comprises a first rod 304, a second rod 306; a swiveling member 308; and a swiveling shaft 310. The swiveling shaft 310 has a swiveling axis 312 that is positioned stationary with respect to the first axis 206 and that lies in a specific plane comprising the first axis 206. The position and orientation of swiveling shaft 310 are fixed by mounting the swiveling shaft 310 in a support 311, fixed to the first shaft 402 and carrying the swiveling shaft 310 in a swiveling bearing 313. The swiveling bearing 313 comprises, e.g., a plain bearing. The swiveling member 308 has a top part 314 and a bottom part 316. The top part 314 of the swiveling member 308 has a first end 318 and a second end 320. The bottom part 316 is mounted to the swiveling shaft 310 for swiveling around the swiveling axis 312. The first rod 304 is coupled between the first end 318 and a first portion 322 of the first blade base 204. The second rod 306 is coupled between the second end 320 and a second portion 404 of the first blade base 204.

Note that the sizes of the hub bearing 502 and of the swiveling bearing 313 are small compared to the characteristic dimensions of the first hub base 202 and of the first blade base 204.

The first rod 304 is connected to the first end 318 of the swiveling member 308 via a first joint 324, e.g., a first ball joint or a first rod end bearing. The second rod 306 is coupled to the second end 320 of the swiveling member 308 via a second joint 326, e.g., a second ball joint or a second rod end bearing. The first rod 304 is coupled to the blade base 204 via a third joint 328, e.g., a third ball joint or a third rod end bearing. The second rod 306 is coupled to the blade base 204 via a fourth joint 330, e.g., a fourth ball joint and a fourth rod end bearing.

The mechanical linkage described above, can be considered a modification of a linkage configuration that is known in the literature as the “Roberts' linkage”, discussed earlier.

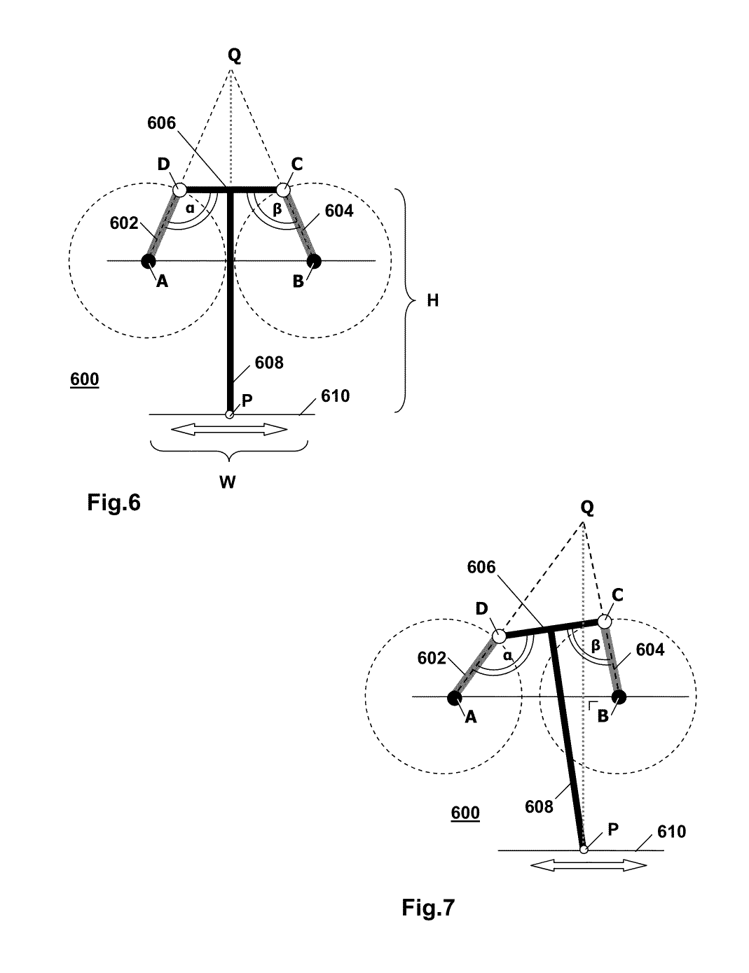

FIGS. 6 and 7 illustrate an example of the Roberts' linkage 600. The Roberts' linkage 600 is a planar linkage in the sense that the components of the Roberts' linkage 600 move in a plane. The Roberts' linkage 600 comprises following components: a first arm 602, a second arm 604, and an intermediate element that comprises a cross-bar 606 and a tail-part 608. The tail-part 608 has an end location “P”. The first arm 602 and the second arm 604 have equal lengths.

The first arm 602 is mounted so as to be able to pivot around a first axis at a first location “A”. The first axis at the first location “A” runs perpendicular to the plane of the drawing in FIG. 6. Likewise, the second arm 604 is mounted so as to be able to pivot around a second axis at a second location “B”. The second axis at the second location “B” runs perpendicularly to the plane of the diagram of FIG. 6.

The first arm 602 and the cross-bar 606 are coupled at a fourth location “D” so as to allow a first angle “α” between the first arm 602 and the cross-bar 606 to vary in the plane of the drawing. Likewise, the second arm 604 and the cross-bar 606 are coupled at a third location “C” so as to allow a second angle “β” between the second arm 604 and the cross-bar 606 to vary in the plane of the drawing. The tail-part 608 and the cross-bar 606 are connected to each other so as to have the fourth location “D”, the third location “C” and the end location “P” form an isosceles triangle.

Assume that the first location “A” and the second location “B” are fixed with regard to a reference frame. A change in the first angle “α”, and a change in the second angle “β” are interdependent as a result of the constraint formed by the cross-bar 606 attached to the first arm 602 and to the second arm 606. The change in the first angle “α”, and the change in the second angle “β” control the movement of the end location “P” so as to trace, in good approximation, a segment 610 of a straight line, parallel to the line connecting the first location “A” and the second location “B”. By increasing the ratio of a height “H” of the Roberts' linkage 600 to a width “W” of the Roberts' linkage 600, the accuracy of the straight motion may be improved. The width “W” is measured in a horizontal direction parallel to the segment 610, and the height “H” is measured in the vertical direction.

As mentioned, the Roberts' linkage 600 is a planar linkage whose components move in a planar space. The diagrams of FIGS. 6 and 7 illustrate different orientations of the components of the Roberts' linkage 600, and different positions of the third location “C”, of the fourth location “D” and of the end location “P” relative to the first location “A” and the second location “B”. Clearly, if the end location “P” is held stationary, and if the first location “A” and the second location “B” are allowed to slide horizontally parallel to the segment 610, while a distance between the first location “A” and the second location “B” is kept fixed, similar considerations apply with regard to the different orientations of the components and with regard to the different positions. In this latter case, the position of the end location “P” does not change when the first location “A” and the second location “B” are allowed to slide horizontally and in unison, under the constraint imposed by the cross-bar 606 that is connected to the first arm 602 and to the second arm 604. Note that the intermediate element formed by the cross-bar 606 and the tail-part 608 changes its orientation with regard to the horizontal segment 610 according to a rotation about an axis perpendicular to the drawing.

Now, consider a scenario wherein the Roberts' linkage is embedded in a three-dimensional space. Consider the first location “A” and the second location “B”” being allowed to move in unison along an arc segment of a horizontal circle instead of along a straight segment of a horizontal line; and consider that the third location “C” and the fourth location “D” are to remain on a circle cylinder extending in the vertical direction and defined by the horizontal circle. It turns out that the end location “P” can still be held stationary if the intermediate element, formed by the cross-bar 606 and the tail-part 608, is allowed to rotate about an intermediate axis that is tilted with respect to the vertical direction, i.e., the intermediate axis has a vertical component and a horizontal component in a direction perpendicular to the plane of the drawing of FIG. 6 This is the basis for the mechanical linkage shown in the diagrams of FIGS. 3, 4 and 5, wherein the intermediate axis corresponds to the swiveling axis 312. The first arm 602 corresponds then to the first rod 304; the second arm 604 corresponds to the second rod 306; the cross-bar 606 corresponds to the top part 314 of the swiveling member 308; the tail-part 608 corresponds to the bottom part 316 of the swiveling member 308; the first location “A” corresponds to the first portion 322 of the first blade base 204; the second location “B” corresponds to the second portion 404 of the first blade base 204; the third location “C” corresponds to the second end 320 of the top part 314 of the swiveling member 308; the fourth location “D” corresponds to the first end 318 of the top part 314 of the swiveling member 308; and the end location “P” corresponds to the location where the bottom part 316 of the swiveling member 308 is mounted to the swiveling shaft 310.

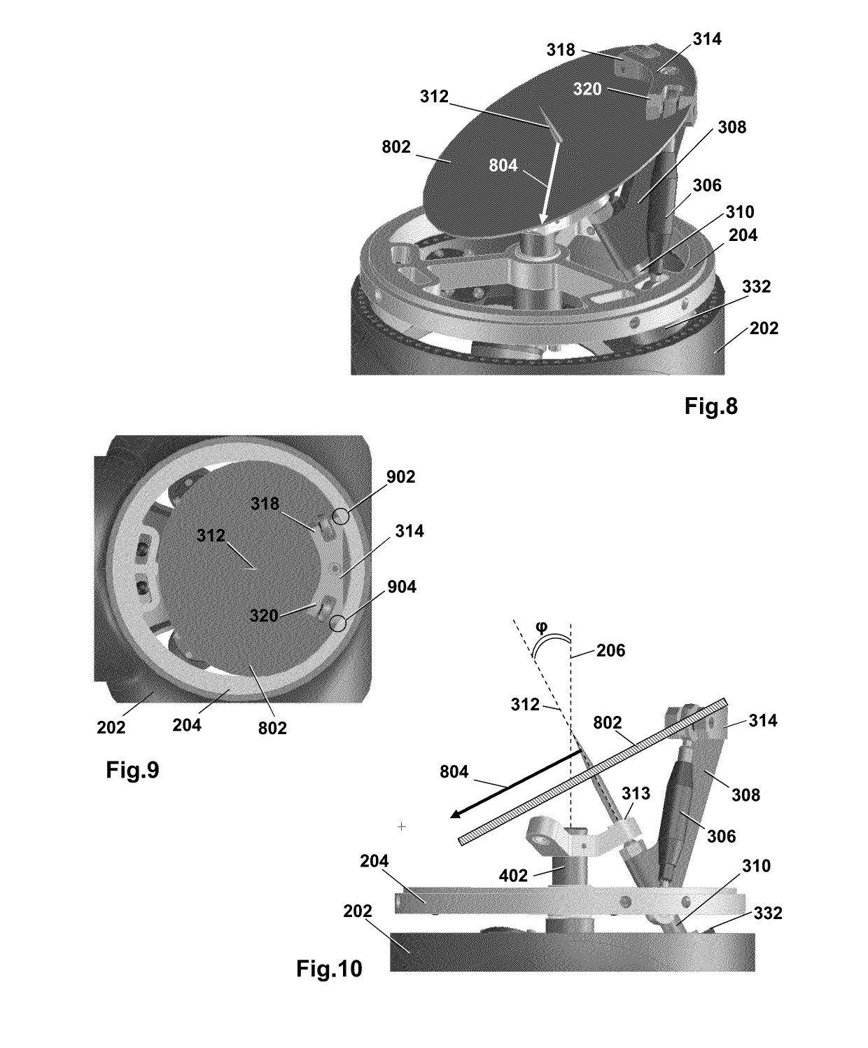

FIGS. 8, 9 and 10 illustrate the role of design parameters relevant to the model embodiment as discussed above with reference to FIGS. 3, 4 and 5. Different ones of the diagrams of FIGS. 8, 9 and 10 show different views of the model embodiment. In the paragraphs below, reference is made to the diagrams of FIG. 8, FIG. 9 and FIG. 10 together, as different features of the design are better represented in the different views provided by the diagrams of FIG. 8, FIG. 9 and FIG. 10. Throughout the diagrams, the first digit of a reference numeral of a particular feature corresponds to the sequence number of the particular one of FIG. 8, FIG. 9 and FIG. 10, wherein the particular feature has been introduced first. For example, the feature with reference numeral 802 (“imaginary circular disc”) is introduced for the first time in the diagram of FIG. 8, whereas the feature with reference numeral 902 (“first reference location”) is introduced for the first time in the diagram of FIG. 9.

In the diagram of FIG. 8, an imaginary circular disc 802 is shown, which is oriented perpendicularly to the swiveling axis 312. A perimeter of the imaginary disc 802 cuts through a first reference location 902 at the first end 318 of the top part 314 of the swiveling member 308, and a second reference location 904 at the second end 320 of the top part 314 of the swiveling member 308. When the swiveling member 308 is swiveling, the first reference location 902 traces a first path in three-dimensional space and the second reference location 904 traces a second path in three-dimensional space. The first path and the second path are circle-segments of the perimeter of the imaginary disc 802. That is, the first reference location 902 and the second reference location 904 are those locations at the swiveling member 308 that lie furthest from the first axis 206. Accordingly, the first reference location 902 and the second reference location 904 determine a radius 804 of the imaginary disc 802.

The swiveling axis 312 makes an angle “φ” with the first axis 206.

If the angle “φ” is too small, the motion of the swiveling member 308 will be inclined too much to the first axis 206. As a result, the distribution of the mechanical loads on the first hub base 202 and the first blade base 204 via the first rod 304 and the second rod 306 is not optimal, as the first rod 304 and the second rod 306 are preferably kept as far away as possible from the first axis 206 so as to contribute effectively to the bending stiffness of the pitch adjustment mechanism as a whole.

If the angle “φ” is made too large, the swiveling axis 312 becomes oriented almost horizontally, as a result of which the conventional, planar Roberts linkage configuration emerges. The excursion of the swiveling member 308 then tends to protrude beyond the outer perimeter of the first blade base 204, which, in practice, implies that the swiveling member 308 will hit the inner wall of the first blade 104.

Accordingly the values of the design parameters need to be determined that characterize a spatial configuration of the pitch adjustment mechanism which, in operational use, will not collide with the cylindrical inner wall the first blade 104, minimize an axial displacement of the first blade 104 relative to the first hub base 202, allow a maximum angular motion and give rise to a maximum stiffness. One way to determine the values of these design parameters may be the following.

Step-1: Maximize an angular motion by maximizing a distance between the third joint 328 and the fourth joint 330 joint at the first blade base 204. A larger distance results in more angular motion. This distance is restricted by the size of the third joint 328 and the fourth joint 330 and the size of the construction around them.

Step-2: Choose a height of the swiveling member 308 as measured in the axial direction along the first axis 206. In general, the resulting axial motion after optimization of the spatial configuration will be smaller when using a longer first rod 304 and a longer second rod 306, and when using a greater height of the swiveling member 308. The internal relative motions of the mechanical linkage and of the first joint 324, the second joint 326, the third joint 328, and the fourth joint 330 will be reduced by extending the axial dimension (i.e., as measured along the first axis 206. Extending the axial dimension of the mechanical linkage, however, will result in a heavier mechanical linkage that, in addition, is more sensitive to buckling.

Step-3: Choose a starting value of the angle “φ” between the swiveling axis 312 and the first axis 206.

Step-4: Consider the imaginary disc 802 around the swiveling axis 312 that touches the top of the swiveling member 308 at the first reference location 902 and the second reference location 904.

Step-5: Determine the projection of the imaginary disc 802 along the first axis 206 onto the first hub base 202.

Step-6: If the projection of the imaginary disc 802 extends beyond the circular inner wall of the first blade 104, the swiveling member 308 will collide with the first blade 104. Then, the angle “φ” between the swiveling axis 312 and the first axis 206 is to be decreased.

Step-7: If the projection of the imaginary disc 802 does not extend beyond the circular inner wall of the first blade 104, the motion of the swiveling member 308 will turn towards the first axis 206. Then, the angle “φ” between the swiveling axis 312 and the first axis 206 is to be increased.

Step-8: Reduce the axial motion of the first blade base 204 by varying the distance between the first joint 324 and the second joint 326 to the swivel member.

Step-8A: If the first blade base 204 moves down (i.e., towards the first hub base 202) when the top part 314 of the swiveling member 308 departs from a horizontal orientation that the top part 314 assumes with the swiveling member 308 is in its center position (i.e., when a line through the heart of the first joint 324 and the heart of the second joint 326 starts making a non-zero angle with a plane perpendicular to the first axis 206), the distance between the first joint 324 and the second joint 326 is increased.

Step-8B: If the first blade base 204 moves up (i.e., away from the first hub base 202) when the top part 314 of the swiveling member 308 departs from the horizontal orientation that the top part 314 assumes with the swiveling member 308 is in its center position (i.e., when a line through the heart of the first joint 324 and the heart of the second joint 326 starts making a non-zero angle with a plane perpendicular to the first axis 206), the distance between the first joint 324 and the second joint 326 is decreased.

Step-9: Repeat step 8 until a distance between the first hub base 202 and the first blade base 204 with the swiveling member 308 in its center position equals the distance between the first hub base 202 and the first blade base 204 with the swiveling member 308 having rotated over a pre-determined rotation angle (e.g., +450) around the swiveling axis 312 relative to the center position.

In the above it is assumed that the swiveling member 308 has a plane of symmetry and that the first rod 304 and the second rod 306 have equal lengths.

Actuation of the pitch adjustment mechanism may be implemented, for example, by means of driving the swiveling shaft 310 by an actuator 332, e.g., an electric motor or a hydraulic motor so as to turn the swiveling shaft 310 in a controlled manner. The turning of the swiveling shaft 310 causes the swiveling member 308 to swivel around the swiveling axis 312 and, as a result, the first hub base 202 and the first blade base 204 to rotate coaxially. In case the pitch adjustment mechanism comprises multiple mechanical linkages, each having the configuration described above, each respective one of the mechanical linkages comprises a respective one of multiple swiveling shafts to which a respective one of multiple swiveling members is attached. The multiple swiveling shafts are then driven in unison. For example, each respective swiveling shaft is then driven by a respective actuator. The diagrams of FIGS. 3, 4 and 5 show the pitch adjustment mechanism comprising three mechanical linkages of similar configuration, wherein each respective one of the three swiveling shafts is driven by a respective one of three actuators: the actuator 332, a further actuator 334 and another actuator 406.

1. A rotary mechanism comprising a first component and a second component configured for coaxial rotation relative to one another around a first axis, wherein:
the first component and the second component are coupled via a mechanical linkage that is configured for constraining a relative movement of the first component and the second component to the coaxial rotation around the first axis;
the mechanical linkage comprises:
a first rod;
a second rod;
a swiveling member; and
a swiveling shaft;
the swiveling shaft has a swiveling axis;
the swiveling member has a top part and a bottom part;
the top part of the swiveling member has a first end and a second end, different from the first end;
the bottom part is mounted to the swiveling shaft for swiveling around the swiveling axis;
the swiveling axis and the first axis span a specific plane that is stationary with respect to a specific one of the first component and the second component;
the first rod is coupled between the first end and a first portion of the specific one of the first component and the second component; and
the second rod is coupled between the second end and a second portion of the specific one of the first component and the second component, different from the first portion.

2. The rotary mechanism of claim 1, wherein:
the specific one of the first component and the second component has a first shaft coaxial with the first axis; and
the other one of the first component and the second component engages with the specific shaft via a bearing.

3. The rotary mechanism of claim 1, comprising at least one of the following characteristics:
the first rod is coupled to the first end of the swiveling member via a first joint that comprises one of: a first ball joint and a first rod end bearing;
the second rod is coupled to the second end of the swiveling member via a second joint that comprises one of: a second ball joint and a second rod end bearing;
the first rod is coupled to the specific one of the first component and the second component via a third joint that comprises one of: a third ball joint and a third rod end bearing; and
the second rod is coupled to the specific one of the first component and the second component via a fourth joint that comprises one of: a fourth ball joint and a fourth rod end bearing.

4. The rotary mechanism of claim 1, wherein:
the rotary mechanism comprises a rotor hub and a blade mounted to the rotor hub;
the blade extends away from the rotor hub in a substantially radial direction relative to an axis of rotation of the rotor hub in operational use of the rotary mechanism;
the rotor hub accommodates the first component;
the blade accommodates the second component;
the rotary mechanism comprises a pitch adjustment mechanism;
the pitch adjustment mechanism is configured for controllably adjusting a pitch of the blade by turning the second part relative to the first part around the first axis;
the pitch adjustment mechanism comprises the mechanical linkage.

5. (canceled)

6. The rotary mechanism of claim 4,
wherein:
the blade has a hollow room; and
the pitch adjustment mechanism partially extends into the hollow room of the blade in operational use of the rotary mechanism.

7. (canceled)

8. The rotary mechanism of claim 1, wherein an angle (φ) between the first axis and the swiveling axis is less than 90 degrees.

9. The rotary mechanism of claim 2, wherein the rotary mechanism comprises a support connected to the first shaft for supporting the swiveling shaft via a swiveling bearing.

10. The rotary mechanism of claim 9, wherein the support is configured for supporting three swiveling shafts for three swiveling members arranged around the first shaft.
